(19) United States
(12) Patent Application Publication
(10) Pub. No.: US 2009/0263593 A1
(43) Pub. Date: Oct. 22, 2009

(54) METHOD FOR MANUFACTURING CARBON FILM

(75) Inventors: Satoshi Hamaguchi, Kyoto (JP); Yasuo Murakami, Fujisawa-shi (JP)

Correspondence Address: FITZPATRICK CELLA HARPER & SCINTO, 30 ROCKEFELLER PLAZA, NEW YORK, NY, 10112, US

(73) Assignees: OSAKA UNIVERSITY, Suita-shi (JP); CANON ANELVA CORPORATION, Kawasaki-shi (JP)

(21) Appl. No.: 12/423,217

(22) Filed: Apr. 14, 2009

(30) Foreign Application Priority Data
Apr. 18, 2008 (JP) 2008-109129

(51) Int. Cl. H05H 1/24

(52) U.S. Cl. 427/577

(57) ABSTRACT

The present invention provides a method for manufacturing a hard carbon film having a high sp3 bond ratio and excellent film quality. In one embodiment of the present invention, CH₃ ions and CH₃ radicals in plasma are irradiated to a substrate at an energy of 10 to 50 eV, thereby forming a carbon film having a ratio of sp3 bonds of 40% or higher.

### CROSS-REFERENCES TO RELATED APPLICATIONS

This application also claims the benefit of priority from Japanese Patent Application No. 2008-109129 filed Apr. 18, 2008, the entire contents of which is incorporated herein by reference.

### BACKGROUND OF THE INVENTION

1. Field of the Invention

The present invention relates to a method for manufacturing a hard carbon film, similar to a diamond-like carbon (DLC) film, used as the surface protection film of sliding components, magnetic recording media, tools, and the like, and as an element for electronic devices, such as electron-emitting devices.

2. Related Background Art

As a method for performing the surface treatment of materials, there is used a method for forming a hard film. As the materials, titanium nitride, boron nitride, zirconium nitride, and the like are applied. Japanese Patent Application Laid-Open No. 2003-34865 and Materials Science and Engineering R37 (2002) pp. 129-281 describe a method for forming a hard carbon film and the purpose of use thereof.

In a case where a hard material of the related art is used as the surface protection film of a sliding component, a magnetic recording medium, a tool or the like, there has arisen the problem that it is not possible to maintain product characteristics over a prolonged period of time due to the wear of the protection film during the use of a product. In order to solve this problem, a material harder than a conventional hard material or a material having a low friction coefficient, for example, may be used. Hence, there is used an amorphous carbon film, where it is considered desirable for the ratio of sp3 bonds contained therein, which are thought to improve film properties, to be as high as possible. Sp2 and sp bonds rather than sp3 bonds are produced, however, depending on a film-forming method or film-forming parameters, thus causing a degradation in film characteristics. That is, there is a demand for a method of efficiently forming sp3 bonds.

### SUMMARY OF THE INVENTION

It is an object of the present invention to provide a method for manufacturing a hard carbon film having a high sp3 bond ratio (ratio of sp3 bonds to all bonds) and excellent film quality.

In order to achieve the above-described object, in the present invention, CH₃ ions and CH₃ radicals generated in a plasma atmosphere are used to deposit a carbon film on a substrate by controlling the irradiation energy of these ions and radicals. As the irradiation energy, it is desirable to apply an energy level within the range of 10 to 50 eV, more preferably, an energy level near 20 eV, to deposit a thin film. By controlling the irradiation energy of CH₃ ions and/or CH₃ radicals as described above, it is possible to stably generate sp3 covalent bonds among carbon atoms, thereby providing a hard material, electron-emitting characteristics and a highly wear-resistant device superior to those of the related art.

A first aspect of the present invention is a method for manufacturing a carbon film including the steps of: preparing a substrate; and irradiating CH₃ ions and CH₃ radicals in plasma to the substrate at an energy of 10 to 50 eV, thereby depositing a carbon film on the substrate.

A second aspect of the present invention is a method for manufacturing a carbon film including the steps of: placing a substrate within a chamber capable of being depressurized to a pressure lower than the atmospheric pressure; supplying a gas of a carbon-containing compound and a hydrogen gas into the chamber; and generating plasma within the chamber supplied with the gas of the compound and the hydrogen gas, thereby producing CH₃ ions and CH₃ radicals, and irradiating the CH₃ ions and the CH₃ radicals to the substrate at an energy of 10 to 50 eV, thereby depositing a carbon film on the substrate.

According to the present invention, it is possible to stably form sp3 bonds among carbon atoms in an amorphous carbon thin film. Thus, it is possible to form a carbon thin film for sliding components and the like requiring a high degree of hardness and wear resistance and a carbon thin film exhibiting high-level device characteristics.

### BRIEF DESCRIPTION OF THE DRAWINGS

FIG. 1A is a configuration diagram showing an overview of a DC plasma-enhanced CVD apparatus according to an embodiment of the present invention.

FIG. 1B is another configuration diagram showing an overview of a DC plasma-enhanced CVD apparatus according to an embodiment of the present invention.

FIG. 2 is a characteristic drawing representing adsorption probability with respect to irradiation energy in an embodiment and a comparative example of the present invention.

FIG. 3 is a characteristic drawing representing an sp3 bond ratio with respect to irradiation energy in an embodiment and a comparative example of the present invention.

### DESCRIPTION OF THE PREFERRED EMBODIMENTS

Hereinafter, exemplary embodiments of the present invention will be described on the basis of the accompanying drawings. Note that components having the same functions are denoted by like reference numerals in the drawings to be explained herein and will not be explained again.

In the present invention, a study was made based on analytical experiments using molecular dynamics when considering a method for forming a hard carbon film having sp3 bonds among carbon atoms. The characteristic feature of this technique is that it is possible to evaluate the behavior of molecules and the process of film formation after selecting the type of molecules and the energy thereof. A deposition simulation analysis conducted on an amorphous carbon substrate by varying the irradiation energy of CH₃ in plasma from several eV to 50 eV has proved that at 20 eV, it is possible to form a film which has the highest adsorption probability, i.e., the highest deposition rate, and the sp3 ratio of which is near 100%. Accordingly, in the present invention, CH₃ ions and CH₃ radicals in plasma are irradiated to the substrate at an energy of 10 to 50 eV, preferably, 20 to 50 eV.

Hereinafter, embodiments of the present invention will be described in detail on the basis of the accompanying drawings.

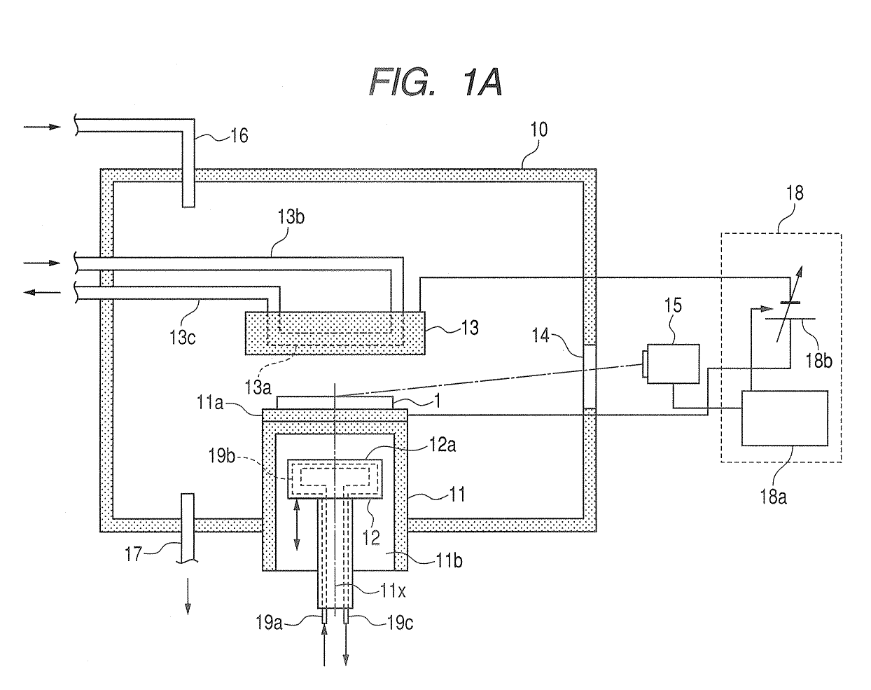

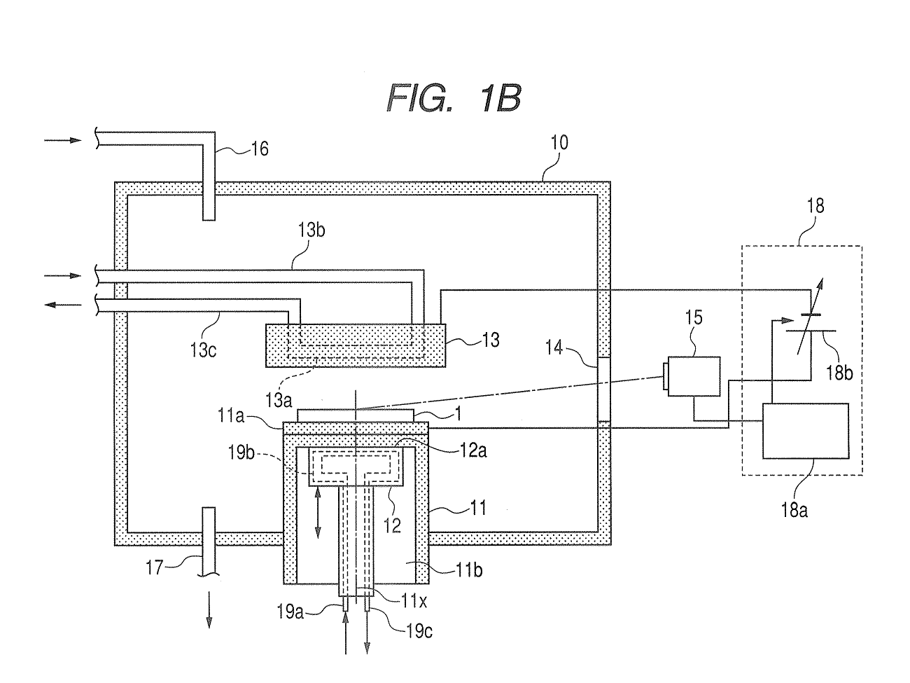

FIGS. 1A and 1B show a DC plasma-enhanced CVD apparatus used in the present invention.

This DC plasma-enhanced CVD apparatus is used to form a film on a surface of a substrate 1 being processed and is provided with a chamber 10 for shielding the substrate 1 from outside air.

A steel stage 11 is arranged within the chamber 10 and a disk-shaped anode 11a made of a metal having high thermal conductivity and a high melting point is mounted on the upper portion of the stage 11. The substrate 1 is fixed onto the mounting surface of the upper side of the anode 11a. The stage 11 is set so as to rotate along with the anode 11a around an axis 11x. As the material of the anode 11a, a metal such as molybdenum (thermal conductivity: 138 W/m•K, melting point: 2620° C.) is preferably used.

A closed space 11b is provided on the lower side of the anode 11a and a cooling member 12 is arranged in the space 11b. Thus, the apparatus is structured so that the cooling member 12 is enabled by an unillustrated movement mechanism to freely move up and down as shown by an arrow. The cooling member 12 is formed of a metal, such as copper, having high thermal conductivity. A cooling medium, such as cooled water or a cooled calcium chlorite solution, enters from a pipe line 19a into a flow path 19b within the cooling member 12 and circulates therethrough, so as to be drained out of a pipe line 19c, thereby cooling the cooling member 12 as a whole.

Accordingly, when a surface 12a of the cooling member 12 abuts against the lower surface of the stage 11, as shown in FIG. 1B, as a result of the cooling member 12 moving upward, the stage 11 thus abutted cools the anode 11a positioned in the upper portion thereof. Thus, the apparatus is structured so that the anode 11a removes the heat of the substrate 1. That is, the cooling medium sent out of the pipe line 19a exchanges heat with the substrate 1 at part of the flow path 19b near the surface 12a, thereby lowering the temperature of the substrate 1. In addition, the heated cooling medium is moved from the flow path 19b to the pipe line 19c and is drained therefrom. The cooling medium drained out of the pipe line 19c is cooled by an unillustrated cooling apparatus and is once again circulated, so as to be sent out into the pipe line 19a. In order to evenly cool the substrate 1 in the plane direction thereof, the surface 12a of the cooling member 12 is preferably similar in shape to the substrate 1 and slightly larger than the substrate 1. In addition, the apparatus is preferably structured to allow the flow path 19b to flow the cooling medium, so that the surface 12a has a uniform temperature.

The space 11b provided on the lower side of the anode 11a is divided off by the stage 11. A gas is encapsulated in the space, or the space is in an atmosphere depressurized to a pressure lower than the atmospheric pressure.

A cathode 13 is arranged above the anode 11a at a certain distance therefrom, and is opposed to the anode 11a.

A flow path 13a for the cooling medium to flow through is formed within the cathode 13, and pipe lines 13b and 13c are attached to the respective ends of the flow path. The pipe lines 13b and 13c penetrate through holes formed in the chamber 10 and communicate with the flow path 13a. The holes of the chamber 10, through which the pipe lines 13b and 13c pass, are sealed with a sealing agent, thereby ensuring the airtightness of the chamber 10. The cooling medium flows through the pipe line 13b, the flow path 13a, and the pipe line 13c, thereby suppressing heat generation in the cathode 13. As the cooling medium, water, a calcium chlorite solution, or the like is preferred.

A window 14 is formed on a side surface of the chamber 10 to enable observation into the chamber 10. A heat-resistant glass is fit in the window 14 to ensure the airtightness of the chamber 10. A radiation thermometer 15 for measuring the temperature of the substrate 1 through the glass of the window 14 is arranged outside the chamber 10.

This DC plasma-enhanced CVD apparatus includes a raw material system (illustration omitted) for introducing a raw material gas through a gas-supplying pipe line 16, an exhaust system (illustration omitted) for adjusting the internal pressure of the chamber 10 by exhausting a gas from within the chamber 10 through an exhaust pipe line 17, and an output setting unit 18.

The respective pipe lines 16 and 17 pass through holes provided in the chamber 10. Portions between these holes and the outer circumferences of the pipe lines 16 and 17 are sealed with a sealing material, thereby ensuring the airtightness of the chamber 10.

The output setting unit 18 is a control apparatus used to set a voltage or current value to be applied between the anode 11a and the cathode 13, and includes a variable power supply 18b. The output setting unit 18 is connected to the anode 11a and the cathode 13, respectively, with lead wires. The respective lead wires pass through holes provided in the chamber 10. The holes of the chamber 10 through which the lead wires are passed are sealed with a sealing material.

The output setting unit 18 includes a control unit 18a, and the control unit 18a is connected to the radiation thermometer 15 with a lead wire. The control unit 18a, when started up, refers to the temperature of the substrate 1 measured by the radiation thermometer 15 and adjusts a voltage or current value applied between the anode 11a and the cathode 13, so that the temperature of the substrate 1 is set to a predetermined value.

Next, an explanation will be made of a film-forming process in which a carbon film is formed on the substrate 1 using the DC plasma-enhanced CVD apparatus shown in FIG. 1.

In the film-forming process, a glass substrate, for example, is first cut out and then fully degreased and ultrasonic-cleaned using ethanol or acetone. Next, an amorphous carbon film having a hydrogen atom content of no higher than 0.01 atom % is formed on the glass substrate, thereby providing the glass substrate as the substrate 1. The amorphous carbon film having a hydrogen atom content of no higher than 0.01 atom % may be fabricated by a Cat-CVD(Catalytic Chemical Vapor Deposition) method using a methane gas. The hydrogen atom content in the amorphous carbon film at this time is preferably 0.001 to 0.1 atom %.

This substrate 1 is placed on the anode 11a of the DC plasma-enhanced CVD apparatus having the configuration shown by way of example in FIG. 1.

When the placement of the substrate 1 is completed, the chamber 10 is depressurized using the exhaust system. Then, a raw material gas including a gas of a compound containing carbon in the hydrocarbon composition thereof, such as methane, ethane or propane (carbon-containing compound) and a hydrogen gas is introduced from the gas-supplying pipe line 16.

The ratio of the gas of the carbon-containing compound in the raw material gas is preferably within the range from 3 to 30 volume % of the total volume. For example, the flow rate of methane is set to 50 sccm(2.5×10⁻² l/min), the flow rate of hydrogen is set to 500 sccm(2.5×10⁻¹ l/min), and the total pressure is set to 0.05 to 1.5 atm, preferably, 0.07 to 0.1 atm.

The substrate 1 is set to room temperature (for example, 20° C.) by the cooling member 12 within the stage 11. In addition, the anode 11a is rotated along with the substrate 1 at 10 rpm, so that a temperature variation on the substrate 1 falls within 5%. DC power is applied between the anode 11a and the cathode 13 to generate plasma, and a plasma state and the temperature of the substrate 1 is controlled.

The cooling member 12 is sufficiently segregated from the anode 11a so as not to affect the temperature thereof. The radiation thermometer 15 is set so as to determine the temperature from heat radiation only on the substrate 1-side surface of the anode 11a by subtracting the plasma radiation of the microwave/DC plasma-enhanced CVD apparatus.

Following, without interruption, the time when a hard carbon film to serve as a foundation film is formed to an adequate thickness, the cooling member 12 far lower in temperature than the plasma-heated anode 11a is raised 100 mm, without changing the gas atmosphere, so as to abut against the stage 11 and cool the anode 11a (timing T0). At this time, the cooled anode 11a causes the substrate 1 fixed thereon to cool down, and controls the substrate 1-side surface thereof to the same room temperature as that at which the hard carbon film is formed, so that the surface is set to a temperature appropriate for sp3 bond-based film formation. In order to still keep the temperature stable thereafter, it is preferable not to significantly vary the voltage or current values applied to the anode 11a and the cathode 13 at timing T0.

At the completion of film formation, the application of voltage between the anode 11a and the cathode 13 is stopped, and then the supply of the raw material gas is stopped and a nitrogen gas is supplied into the chamber 10 as a purge gas. After the chamber has recovered to normal pressure, the substrate 1 is retrieved in a state of having returned to normal temperature.

As a result of the above-described steps, there is formed a hard carbon film having an sp3 bond ratio of 40% or higher. At this time, it is possible to increase the sp3 bond ratio to 60% or higher, preferably, 80% or higher by adjusting the DC power supply voltage and the degree of vacuum (preferably 10⁻⁶ Pa or lower, more preferably, 10⁻⁷ Pa or lower).

In addition, there can be obtained a resistivity of 1 to 18 kΩ•cm.

While in the above-described embodiment, an explanation has been made by taking as an example in the case where a DC plasma-enhanced CVD apparatus is used, an RF plasma-enhanced CVD apparatus can also be used in the present invention In that case, it is possible to use a microwave (2.45 GHz) RF power source, a radiofrequency wave (13.56 MHz) RF power source, or the like, having a frequency of 10 MHz or higher, as an RF power source.

### EXAMPLES

In order to verify the effect of CH₃ radicals and CH₃ ions and the irradiation energy thereof caused on bonds in an amorphous carbon film, simulation experiments were conducted using a molecular dynamics method. A Brenner type of potential was used to determine intermolecular force in molecular dynamics. The details of the potential are described in, for example, “Physical Review B” Vol. 42, No. 15, pp. 9458-9471 (1990). An amorphous carbon film of low hydrogen content was used for a substrate to be irradiated, and approximately 300 shots of CH₃ were irradiated to the substrate, while varying the irradiation energy from 2 to 50 eV in a room-temperature environment. Consequently, the adhesion provability of carbon and hydrogen and the ratio of bonds newly formed among incident carbon atoms were evaluated from the number of carbon and hydrogen atoms that adhered to the substrate, after the 300-shot irradiation, while taking into consideration carbon atoms of the substrate that were sputtered and lost.

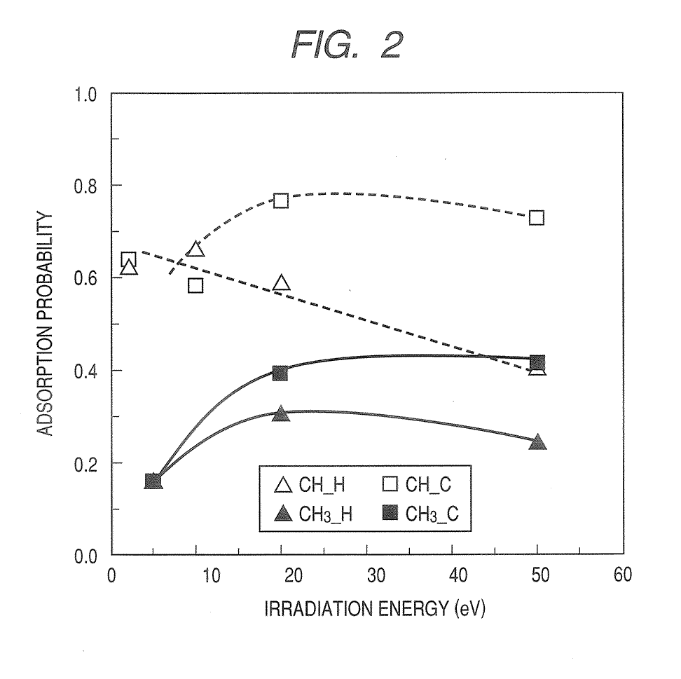

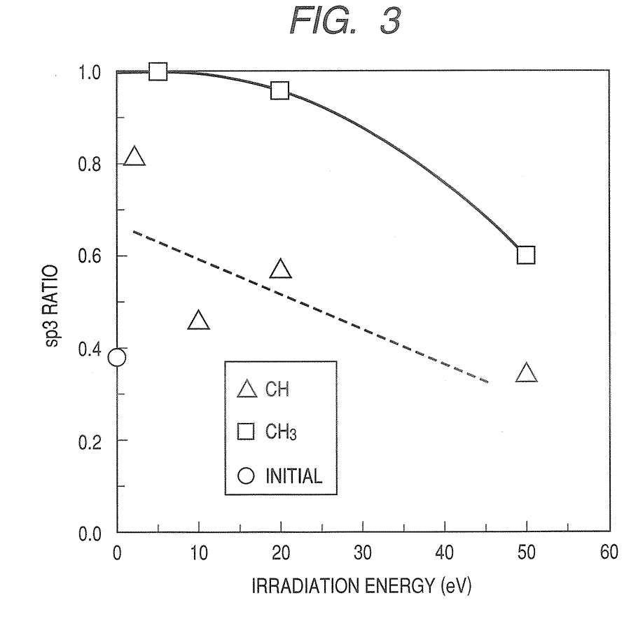

FIGS. 2 and 3 show the result of the evaluation. As shown in FIG. 2, it has proved that the adhesion provability of carbon atoms increases as the irradiation energy increases, and almost reaches a peak at approximately 20 eV. On the other hand, as shown in FIG. 3, an observation of bonds between the carbon atoms of the substrate and the incident carbon atoms has proved that the ratio of sp3 bonds lowers as the irradiation energy of CH₃ increases.

It has proved that this lowering is due to the fact that sp2 bonds, rather than sp3 bonds, which compose a graphite structure begin to form as the irradiation energy increases. From the above-described results, it has been discovered that it is important to form sp3 bonds at an irradiation energy of approximately 20 eV, in order to form the bonds in a stable and productive manner.

### COMPARATIVE EXAMPLES

As comparative examples, FIGS. 2 and 3 respectively show adhesion provability and the ratios of bonds newly formed among the carbon atoms of the substrate and incident carbon atoms when CH radicals or CH ions were irradiated to an amorphous carbon substrate. It is understood from FIG. 2 that the adhesion provability of CH is higher, compared with CH₃. This is because CH has a larger number of unitable bonds than CH₃ and is, therefore, easier to adsorb than CH₃. According to FIG. 3, however, it is known that the sp3 bond ratio of CH is as much as approximately 40% lower, compared with that of CH₃, when the irradiation energy is, for example, 20 eV. This is because sp2 bonds are formed in addition to sp3 bonds. Hence, it is understood that although the adsorption probability of CH₃ lowers since CH₃ has a smaller number of unitable bonds than CH, CH₃ causes sp3 bonding once bonding takes place. There is therefore the high possibility, as a consequence, that an amorphous carbon film having a high sp3 bond ratio is formed.

Note that irradiation energy can be measured using the PPM422 Plasma Process Monitor which is a high-performance quadrupole mass spectrometer made by PFEIFFER.

What is claimed is:

1. A method for manufacturing a carbon film, comprising the steps of:
preparing a substrate; and
irradiating CH₃ ions and CH₃ radicals in plasma to said substrate at an energy of 10 to 50 eV, thereby depositing a carbon film on said substrate.

2. The method for manufacturing a carbon film according to claim 1, wherein said step of deposition irradiates CH₃ ions and CH₃ radicals in said plasma to said substrate at an energy of 20 to 50 eV.

3. The method for manufacturing a carbon film according to claim 1, wherein said deposited carbon film contains sp3 bonds at a bond ratio of 40% or higher.

4. The method for manufacturing a carbon film according to claim 1, wherein said deposited carbon film contains sp3 bonds at a bond ratio of 60% or higher.

5. The method for manufacturing a carbon film according to claim 2, wherein said deposited carbon film contains sp3 bonds at a bond ratio of 40% or higher.

6. The method for manufacturing a carbon film according to claim 2, wherein said deposited carbon film contains sp3 bonds at a bond ratio of 60% or higher.

7. The method for manufacturing a carbon film according to claim 2, wherein said deposited carbon film contains sp3 bonds at a bond ratio of 80% or higher.

8. A method for manufacturing a carbon film, comprising the steps of:
placing a substrate within a chamber capable of being depressurized to a pressure lower than the atmospheric pressure;
supplying a gas of a carbon-containing compound and a hydrogen gas into said chamber; and
generating plasma within said chamber supplied with said gas of said compound and said hydrogen gas, thereby producing CH₃ ions and CH₃ radicals, and irradiating said CH₃ ions and said CH₃ radicals to said substrate at an energy of 10 to 50 eV, thereby depositing a carbon film on said substrate.
